(19) United States
(12) Patent Application Publication
(10) Pub. No.: US 2006/0008313 A1
(43) Pub. Date: Jan. 12, 2006

(54) Lotion stick applicator

(76) Inventor: David M. Wisniewski, Macomb Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/885,377

(22) Filed: Jul. 6, 2004

(51) Int. Cl. A46B 5/02; A47L 11/08; B43K 5/00

(52) U.S. Cl. 401/6; 401/188 R; 401/205

(57) ABSTRACT

A lotion stick applicator having a body with an elongated and arcuately extending stem defining an interior extending passageway. A cylindrical-shaped handle is secured to a first end of said body and incorporates a fluid holding reservoir. A fluid-pressurizing pump mechanism is incorporated into the body, proximate the handle, and in fluidic communication with the extending stem. An applicator is secured to a second end of the stem and includes such as a foam or sponge-like material, the applicator adjusting for selective communication with the fluid flow through the stem. Actuation of the pump mechanism causing fluid to be withdrawn from the reservoir, conveyed along the extending passageway and applied across the applicator.

### BACKGROUND OF THE INVENTION

1. Field of the Invention

The present invention relates generally to an elongated lotion applicating device. More particularly, the present invention teaches an elongated lotion stick applicator combining the features of an attachable, fluid holding reservoir handle, a proximally located pump actuator, an elongated and communicating stem and a pad applicator element secured to an extending end of the stem and which is rotatable between fluid conveying and fluid shut-off positions.

2. Description of the Prior Art

The prior art is well documented with various examples of lotion applicating devices. The typical objective of such devices is to facilitate self-application of lotions or creams, such as to locations as a user's own back or other areas which are typically inaccessible to self-application.

DeForest, U.S. Pat. No. 5,240,339, teaches a body lotion applicator including an extended applicator head for reaching the back and other portions of the body that are difficult to reach. As best illustrated in FIG. 1, a bottle of lotion is attached to a base of a handle and is communicated through the elongated neck and to the applicator head. The head preferably includes a face plate and porous sponge affixed by a retaining ring. The sponge further typically includes an outer layer of a small cell, open-cell foam and an inner body of a large cell, open-cell foam. The sponge is detachable from the head and is replaceable with a coarse-celled exfoliative sponge or similar sponge assembly.

U.S. Pat. No. 4,078,865, to Moser, teaches a liquid applicator which includes an applicator member for receiving a liquid to be applied, an elongated delivery member therefor, a cover including a removable scraping member and an entry part for engaging a container having the liquid to be applied. As with DeForest, an existing container of fluid is attached to the elongated hollow and tubular delivery member.

Byrne, U.S. Pat. No. 6,530,707, teaches a back lotion applicator for dispensing a substance upon a body and including a reservoir for the substance presented at one end of a hollow member. A piston is disposed within the hollow member for communicating with the reservoir and for dispensing the substance from the reservoir to the body. Additionally, structure is presented at another end of the hollow member for activating the piston.

U.S. Pat. No. 5,931,591, issued to McCracken, teaches a lotion applicator device for applying lotion to the skin, and in particular to the back and legs of a user. An elongated handle and head portion with an enlarged base having an annular rim surrounds a mouth and a neck extending from the base and terminating at an open end. The elongated handle is attachable to the open end of the neck and includes a removable cap to facilitate filling of lotion within an interior reservoir.

A lotion dispensing assembly on the head portion includes a pair of overlaying plate members covering the open mouth, the plate members being movable relative to one another to position corresponding apertures formed through each plate member in either an offset relation or an aligned relation, thereby defining closed and open positions to selectively control flow of lotion through the plate members and to an exterior application surface. A cover is removably attached to the head portion, in covering relation to the plate members, to protect the applicator surface from sand, dirt and contact with other objects when the device is not in use.

U.S. Pat. No. 5,592,714, issued to Bernard, teaches a lotion applicator of the type for applying lotion to body areas not easily reached and which includes an angled handle having a first end section, a middle section and a second end section. An elongated stem connects to and extends from the first end, an applicating member rotatably mounting on the elongated stem. A tubular member has a first open end and second closed end, the first open end is connectable to the first end section of the handle for storing the applicating member therein and is connectable to the second end section for extending the length of the handle.

U.S. Pat. No. 5,851,077, issued to Trejo, teaches a sunscreen lotion applicator having a lotion container, tubular handle and a flexible, necked applicator head. The handle is contoured for facilitating not only access to a person's backside for lotion application, but also for being carried on a tool belt of an individual. The handle includes a detachable fill cap having a rough texture for better on/off manipulation, an upper rough textured grip facilitates firm grasping for insertion and removal from a tool belt and a lower rough texture grip for grasping during use.

The applicator head member is constructed in the form of a ball roll-on applicator or cylindrical roller, or further as a replaceable porous dauber covered with a chained cap. The applicator head connects with lotion-container handle via a bellows portion that facilitates flexible manipulation, and adjustment capability while being worn on a tool belt. The head member includes a first chamber region in fluid communication with the main lotion container handle body and a second dispensing chamber region in communication with the applicator ball, as provided. The two chambers are separated by an open/close mechanism which controls the flow of different viscosities of lotions into the dispensing chamber.

Finally, U.S. Pat. No. 4,961,661, issued to Sutton et al., teaches a fluid applicator for applying fluid in a uniform and discrete manner to a remote surface and wherein the applicator has a fibrous pad which is saturated and retains the fluid until applied to a surface. A valve or throttle means controls the amount of fluid in the fibrous pad and a telescoping handle element can be extended to provide an elongate handle for reaching remote areas and to expose a cylindrical fluid vessel having a flexible wall which is compressed to extrude fluid therefrom and into the fibrous pad.

### SUMMARY OF THE PRESENT INVENTION

The present invention discloses an elongated lotion stick applicator which is an improvement over prior art lotion applicating devices in that it provides for quick and efficient self-application of lotions, such as to the back and otherwise inaccessible locations of the user's body. An applicator body includes an elongated and arcuately extending stem defining an interior-extending passageway.

A cylindrical-shaped handle is secured to a first end of the body and incorporates a fluid holding reservoir. In a preferred embodiment, the handle is attached to an end of the body in a fluid-tight manner, and such as through the provision of interengaging threads.

A fluid-pressurizing pump mechanism is incorporated into the body, proximate the handle, and in fluidic communication with the extending stem. An applicator is secured to a second end of the stem and includes such as a foam or sponge-like material. The applicator can be adjusted, such as by rotation, for selective communication with the fluid flow through the stem. Actuation of the pump mechanism causes fluid to be withdrawn from the reservoir, conveyed along the extending passageway and applied across the applicator.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view illustrating the lotion stick in use according to the present invention;

FIG. 2 is a perspective view of the lotion stick illustrated in FIG. 1;

FIG. 3 is an axial cutaway view of the lotion stick and which illustrates the features of the handle reservoir, pump, and fluid conveying passageway extending to the pad applicator;

FIG. 4 is a rotated bottom view of the lotion stick shown in FIG. 3 and further illustrating in phantom the conduit passageway for feeding fluid to the pad applicator;

FIG. 5 is a first sectional view of the applicating head in a fluid conveying position; and

FIG. 6 is a second sectional view of the applicating head in a rotated and fluid shut-off position.

### DETAILED DESCRIPTION OF THE PREFERRED EMBODIMENTS

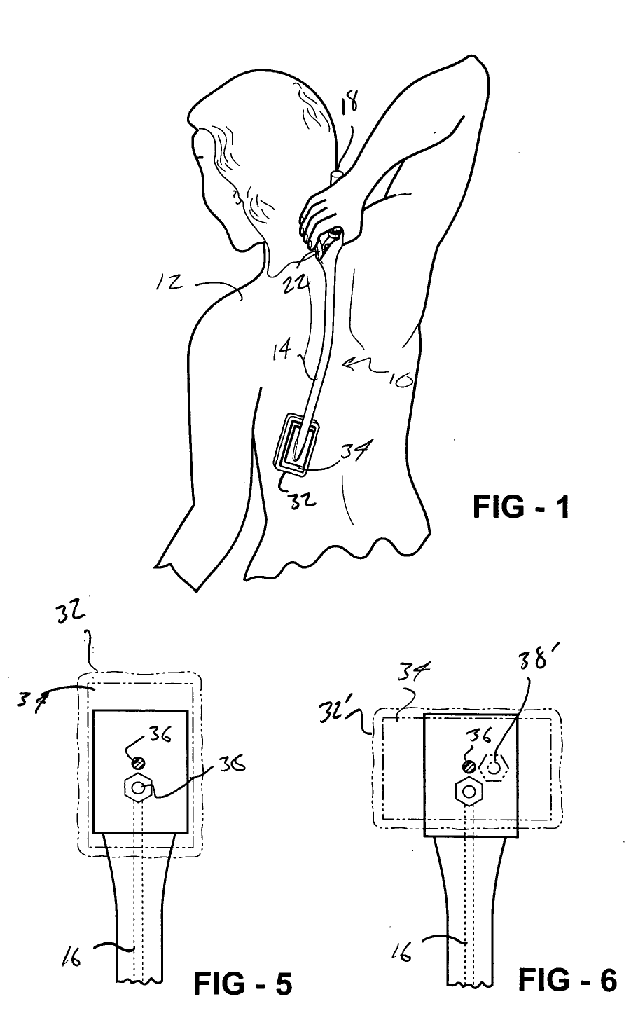

Referring now to FIG. 1, an environmental view is illustrated at 10 of a lotion stick applicator produced according to the present invention. As previously described, the present invention provides for quick and efficient self-application of lotions and the like to typically inaccessible locations such as the user's back 12.

The lotion stick applicator 10 exhibits an elongated body, such as further including an arcuately extending stem 14 exhibiting an interior extending passageway (see inner wall 16). Although illustrated in one extending configuration, it is also understood that the stem 14 may exhibit a reverse bent or other suitable configuration to facilitate the user in self-applicating parts of the body typically inaccessible without the use of some sort of applicating device.

The applicator is typically constructed of a durable plastic or other suitable material exhibiting the necessary properties of strength and resiliency. In one variant, a sanitary-type plastic can be used in the construction of the body, however it is also understood and envisioned that the applicator body can be constructed from any suitable material including a lightweight metal or other material.

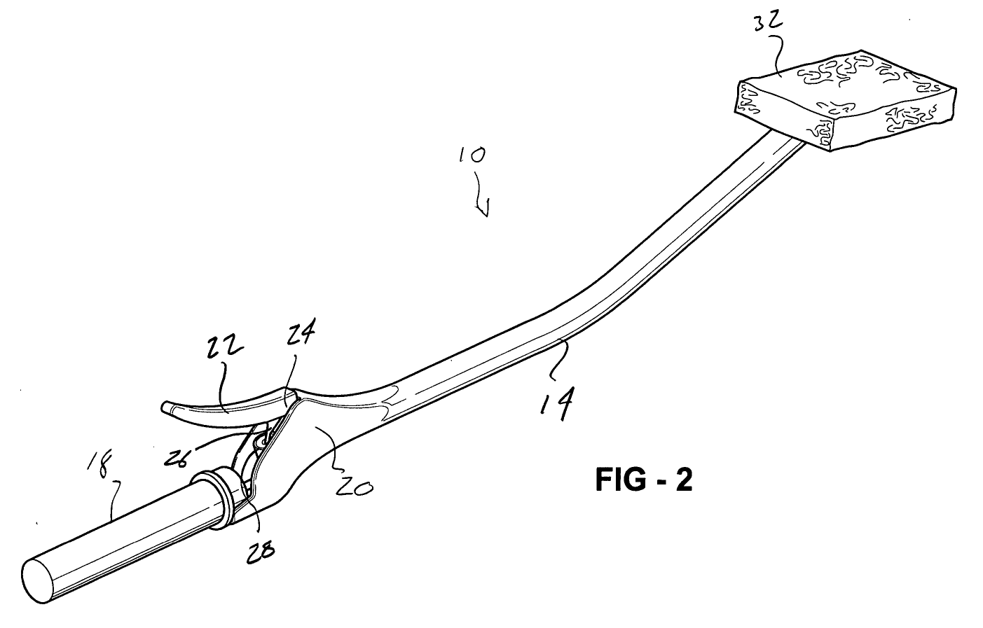

A handle 18 (see FIGS. 2-5) secures to a first end of the body and such as to a portion 20 extending in fluidic communication with the stem 14. The handle 18 in the preferred embodiment is illustrated as an elongated cylinder and which is internally hollowed such that it defines a fluid holding reservoir (such as for containing a lotion, oil, soap, or other liquid).

The preferred embodiments for securing the handle 18 to the body include the provision of interengaging screw threads (such as which can be used in cooperation with a pressure-sealing washer). Alternatively, a bayonet and slot arrangement (not shown) can be employed for securing the fluid holding handle in a push and twist fashion to the body portion 20.

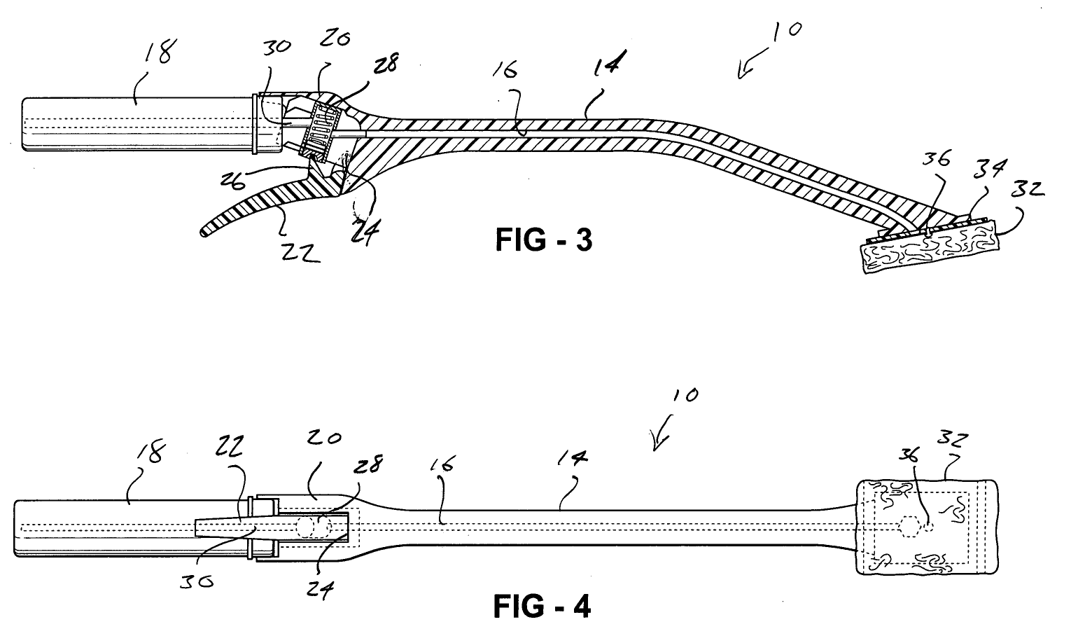

An elongate member 22 (such as an arcuate extending handlebar portion) is pivotally secured, see at 24, to the intermediate body portion 20 (see as best shown in FIG. 3) and extends in partially overlapping fashion relative to the cylindrical handle 18. An inward projection 26 (see again FIGS. 2 and 3) is associated with the elongate member 22 and, upon the user inwardly compressing the elongate member 22 in a direction towards the handle 18, the projection 26 engages a pressurizing flow mechanism 28 incorporated into the body portion 20 and associated with a fluid-pressurizing pump.

The pressurizing flow mechanism 28, in the preferred embodiment, includes a spring-loaded piston unit located intermediate a first inlet passageway 30 (again FIGS. 3 and 4) extending from the fluid holding reservoir built into the handle 18 and the interior extending passageway 16 extending through the stem portion 14 of the elongated body. In application, actuation of the pressurizing flow mechanism causes a suction, or vacuum, to be created on the inlet side (corresponding to the inlet passageway 30), thus drawing fluid in a pressurized fashion through the extending passageway 16. It is also contemplated and understood that, in substitution for the elongated member 22 and spring-loaded pump actuating cylinder 28, other pressure or flow inducing mechanisms can be incorporated for creating the necessary suction or drawing force for the fluid containing reservoir, such further including suction inducing and flexible bellows members and the like.

An applicator 32 exhibits a specified shape and size and further includes a three-dimensional foam or sponge-like material, which secures to a remote extending end of the elongated stem 14. In a preferred embodiment, a substantially planar shaped element 34 is mounted to the body and upon which is secured the three-dimensional material consisting of the applicator 32.

At least one fluid conveying aperture 36 extends through the planar-shaped element 34 and such that the applicator 32 is rotatable between a first position (see also FIG. 5), in which the fluid conveying aperture 36 is in aligning and fluidic communication between the interior extending passageway 16 and the applicator 32 (see position of a hex head 38 defining a terminating location of the interior passageway 16 in fluidic communication with the aperture 36 and sponge 32), and a second rotated position (see as illustrated by a ninety degree rotated position of the sponge 32′ and hex head 38′ and planar support element 34 in FIG. 6) by which the fluid flow is disrupted.

It is therefore evident that the present invention teaches a novel and unique lotion applicating stick which is an improvement over prior art devices in that it provides for quicker and more efficient one-handed manipulation and self-application of a pressurized lotion of other suitable applicating fluid, than which was previously possible.

Having described my invention, other and additional preferred embodiments will become apparent to those skilled in the art to which it pertains, and without deviating from the scope of the appended claims.

I claim:

1. A lotion stick applicator, comprising:
an elongated body defining an interior extending passageway;
a handle secured to a first end of said body and incorporating a fluid holding reservoir;
a fluid-pressurizing pump located in proximity to said handle; and
an applicator secured to a second end of said body;
actuation of said pump causing said fluid to be withdrawn from said reservoir, conveyed along said extending passageway and across said applicator.

2. The lotion stick applicator as described in claim 1, said elongated body exhibiting a specified shape and size and further comprising an arcuate extending stem.

3. The lotion stick applicator as described in claim 1, said handle exhibiting a specified shape and size and further comprising an elongated cylinder.

4. The lotion stick applicator as described in claim 3, further comprising at least one interengaging screw threads and a bayonet and slot attachment for securing said cylinder to said elongated body in a fluid sealing manner.

5. The lotion stick applicator as described in claim 1, further comprising an elongate member pivotally secured to said body and extending in partially overlapping fashion relative to said handle, an inward projection being associated with said elongate member and, upon compressing said elongate member in a direction towards said handle, said projection engaging a pressurizing flow mechanism associated with said fluid-pressurizing pump.

6. The lotion stick applicator as described in claim 5, said pressurizing flow mechanism further comprising a spring-loaded piston unit located intermediate a first passageway extending from said fluid holding reservoir and said interior extending passageway extending through said elongated body.

7. The lotion stick applicator as described in claim 1, said applicator exhibiting a specified shape and size and further comprising at least a three-dimensional foam or sponge-like material.

8. The lotion stick applicator as described in claim 7, further comprising a substantially planar shaped element mounted to said body and upon which is secured said three-dimensional material.

9. The lotion stick applicator as described in claim 8, further comprising at least one fluid conveying aperture extending through said planar shaped element and such that said element is rotatable between a first position, in which said fluid conveying aperture is in aligning and fluidic communication with said interior extending passageway and a second position, in which said fluid flow is disrupted.

10. A lotion stick applicator, comprising:
a body including an elongated and arcuately extending stem defining an interior extending passageway;
a generally cylindrical shaped handle secured to a first end of said body and incorporating a fluid holding reservoir;
a fluid-pressurizing pump mechanism incorporated into said body, intermediate said handle and said extending stem; and
an applicator secured to a second end of said stem;
actuation of said pump mechanism causing said fluid to be withdrawn from said reservoir, conveyed along said extending passageway and applied across said applicator.

11. A lotion stick applicator, comprising:
a body including an elongated and arcuately extending stem defining an interior extending passageway;
a generally cylindrical shaped handle secured to a first end of said body and incorporating a fluid holding reservoir, said handle being releasably secured to said body in a fluid-tight manner;
a fluid-pressurizing pump mechanism incorporated into said body proximate said handle, said pump mechanism including a pressurizing flow mechanism located intermediate a first passageway extending from said fluid holding reservoir and said interior extending passageway extending through said elongated body; and
an applicator secured to a second end of said stem and communicable with a remote extending end of said interior passageway;
actuation of said pump mechanism causing said fluid to be withdrawn from said reservoir, conveyed along said extending passageway and applied across said applicator.
